(19) United States
(12) Patent Application Publication
(10) Pub. No.: US 2013/0199921 A1
(43) Pub. Date: Aug. 8, 2013

(54) Carrier-Gas Humidification-Dehumidification Using Heat-Transfer Members for Enhanced Heat Recovery

(71) Applicant: Ronan Killian McGovern, Cambridge, MA (US)

(72) Inventor: Ronan Killian McGovern, Cambridge, MA (US)

(73) Assignee: Massachusetts Institute of Technology, Cambridge, MA (US)

(21) Appl. No.: 13/760,607

(22) Filed: Feb. 6, 2013

Related U.S. Application Data
(60) Provisional application No. 61/595,732, filed on Feb. 7, 2012.

(51) Int. Cl. C02F 1/04

(52) U.S. Cl. CPC C02F 1/043
USPC 203/10; 261/146

(57) ABSTRACT

A humidification-dehumidification apparatus featuring enhanced heat recovery includes a shared interior wall extending along a vertical axis and defining and separating humidifying and dehumidifying chambers. Heat-transfer members extend through the shared interior wall and across a majority of each chamber, while a spray device is configured to direct a spray of liquid feed composition onto the heat-transfer members inside the humidifying chamber. The liquid feed collects on the heat-transfer members in the humidifying chamber, and water evaporates from the liquid feed on the heat-transfer members, leaving a concentrated remainder of the liquid feed in liquid form. Carrier gas passes through the humidifying chamber where evaporated water is entrained in the carrier gas to form a moist carrier gas that passes from the humidifying chamber to the dehumidifying chamber, where the water vapor condenses from the moist carrier gas on the heat-transfer members.

### RELATED APPLICATION

This application claims the benefit of U.S. Provisional Application No. 61/595,732, filed 7 Feb. 2012, the entire content of which is incorporated herein by reference.

### BACKGROUND

In this century, the shortage of fresh water will surpass the shortage of energy as a global concern for humanity, and these two challenges are inexorably linked, as explained in the “Special Report on Water” in the 20 May 2010 issue of The Economist. Fresh water is one of the most fundamental needs of humans and other organisms; each human needs to consume a minimum of about two liters per day. The world also faces greater freshwater demands from farming and industrial processes.

The hazards posed by insufficient water supplies are particularly acute. A shortage of fresh water may lead to a variety of crises, including famine, disease, death, forced mass migration, cross-region conflict/war, and collapsed ecosystems. Despite the criticality of the need for fresh water and the profound consequences of shortages, supplies of fresh water are particularly constrained. 97.5% of the water on Earth is salty, and about 70% of the remainder is locked up as ice (mostly in ice caps and glaciers), leaving only a fraction of all water on Earth as available fresh (non-saline) water.

Moreover, the earth's water that is fresh and available is not evenly distributed. For example, heavily populated countries, such as India and China, have many regions that are subject to scarce supplies. Further still, the supply of fresh water is often seasonally inconsistent. Meanwhile, demands for fresh water are tightening across the globe. Reservoirs are drying up; aquifers are falling; rivers are dying; and glaciers and ice caps are retracting. Rising populations increase demand, as do shifts in farming and increased industrialization. Climate change poses even more threats in many regions. Consequently, the number of people facing water shortages is increasing. Naturally occurring fresh water, however, is typically confined to regional drainage basins; and transport of water is expensive and energy-intensive.

On the other hand, many of the existing processes for producing fresh water from seawater (or to a lesser degree, from brackish water) require massive amounts of energy. Reverse osmosis (RO) is currently the leading desalination technology. In large-scale plants, the specific electricity required can be as low as 4 kWh/m³ at 40% recovery, compared to the theoretical minimum of around 1 kWh/m³; smaller-scale RO systems (e.g., aboard ships) are less efficient.

Other existing seawater desalination systems include thermal-energy-based multi-stage flash (MSF) distillation, and multi-effect distillation (MED), both of which are energy- and capital-intensive processes. In MSF and MED systems, the maximum brine temperature and the maximum temperature of the heat input are limited in order to avoid calcium sulphate precipitation, which leads to the formation of hard scale on the heat transfer equipment.

Humidification-dehumidification (HDH) desalination systems include a humidifier and a dehumidifier as their main components and use a carrier gas (e.g., air) or a liquid (e.g., water) to communicate energy between the heat source and the brine. In the humidifier, hot seawater comes in direct contact with dry air, and this air becomes heated and humidified. In the dehumidifier, the heated and humidified air is brought into (indirect) contact with cold seawater and gets dehumidified, producing pure water and dehumidified air. Additional MIT patent applications that include additional discussion relating to HDH processes for purifying water include the following: U.S. application Ser. No. 12/554,726, filed 4 Sep. 2009 (attorney docket number mit-13607); U.S. application Ser. No. 12/573,221, filed 5 Oct. 2009 (attorney docket number mit-13622); U.S. application Ser. No. 13/028,170, filed 15 Feb. 2011 (attorney docket number mit-14295); and U.S. application Ser. No. 13/241,907, filed 23 Sep. 2011 (attorney docket number mit-14889).

To date, systems that have attempted to directly transfer heat from the condensation process to the evaporation process, such as carrier gas systems with a common heat-transfer wall across which the liquid feed is poured, have suffered from extremely poor rates of heat transfer between the two (overall heat transfer coefficients on the order of 2 W/m⁻²K). In addition, they provide no effective or coherent means of using the product liquid and, especially, the rejected concentrated stream to preheat the liquid entering the system, thus degrading the energetic efficiency of the system.

### SUMMARY

Methods and apparatus for purifying water or concentrating solute via a humidification-dehumidification process are described herein. Various embodiments of the apparatus and methods may include some or all of the elements, features and steps described below.

A humidification-dehumidification apparatus, described herein, can include the following components: a housing including a shared interior wall extending along a vertical axis and defining a humidifying chamber and a dehumidifying chamber adjacent to the humidifying chamber, wherein the humidifying chamber and the dehumidifying chamber are separated by the shared interior wall, wherein the shared interior wall defines an orifice through which a carrier gas can pass from the humidifying chamber into the dehumidifying chamber; a plurality of heat-transfer members (e.g., rods) extending through the shared interior wall and across a majority of each chamber along a horizontal axis; a spray device is configured to direct a spray of liquid feed onto the heat-transfer members inside the humidifying chamber; and a conduit for feeding the liquid feed through the spray nozzle.

In a method for purifying water or for concentrating solute, as described herein, a liquid feed (including water and at least one other composition dissolved in the water) is sprayed into the humidifying chamber of a humidification-dehumidification apparatus. The liquid feed is collected on the heat-transfer members in the humidifying chamber as the liquid feed passes through the humidifying chamber; and water from the liquid feed that was collected on the heat-transfer members is evaporated, leaving a concentrated remainder of the liquid feed in liquid form; and that concentrated remainder is drained from the humidifying chamber. Meanwhile, a flow of carrier gas is passed through the humidifying chamber in counter-flow to the spray of liquid feed; and the evaporated water from the liquid feed is entrained in the flow of carrier gas to form a moist carrier gas. The flow of the moist carrier gas then passed from the humidifying chamber to the dehumidifying chamber, where water vapor from the moist carrier gas is condensed on the bank of heat-transfer members. Meanwhile, the heat of condensation and sensible heat from cooling the moist carrier gas and the condensed water is transferred across the heat-transfer members from the dehumidifying chamber to the humidifying chamber, allowing heat to be returned to the evaporation process. The condensed water is drained from the dehumidifying chamber to a collection receptacle.

The methods and apparatus can provide all or some of the following advantages: drastically decreasing the size (and thus cost) of such a system and increasing the energy efficiency and simplifying the heating system required to drive the process via the design of a process within which the heat and mass transfer coefficients characteristic of both the evaporation and condensation processes are very high, within which heat is directly recovered from the condensation process to the evaporation process and only heating of the liquid feed is required to drive the process.

### BRIEF DESCRIPTION OF THE DRAWINGS

FIG. 1 is a schematic drawing of a humidification-dehumidification apparatus with the gas and liquid flows illustrated and with heat-transfer members in a pre-humidifier region with additional bars providing additional surface area for evaporative cooling of the liquid stream and heating and humidification of the carrier gas stream.

FIG. 2 is a schematic drawing of a humidification-dehumidification apparatus with the gas and liquid flows illustrated and with a heat-transfer packing material in a pre-humidifier region in the humidification chamber between the spray nozzle and the heat-transfer members extending between chambers.

In the accompanying drawings, like reference characters refer to the same or similar parts throughout the different views; and apostrophes are used to differentiate multiple instances of the same or similar items sharing the same reference numeral. The drawings are not necessarily to scale, emphasis instead being placed upon illustrating particular principles, discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, used or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%, wherein percentages or concentrations expressed herein can be either by weight or by volume) can be understood as being within the scope of the description; likewise, if a particular shape is referenced, the shape is intended to include imperfect variations from ideal shapes, e.g., due to manufacturing tolerances.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to” or “coupled to” another element, it may be directly on, connected or coupled to the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

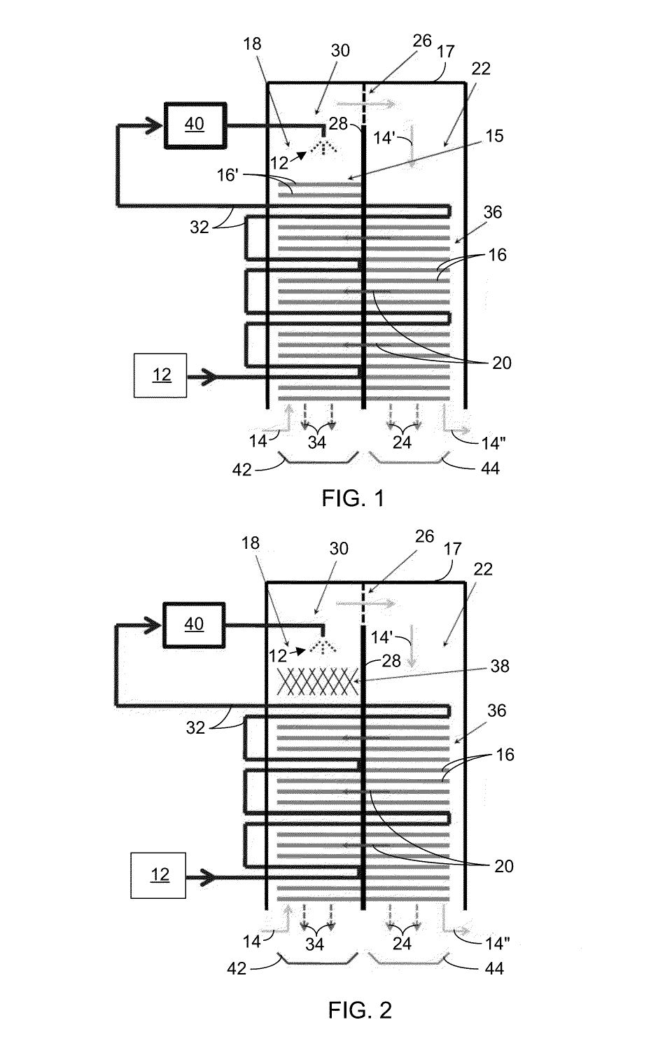

In order to achieve greatly enhanced rates of heat transfer during the process of air humidification, as shown in FIG. 1, a spray of water 12 at a top position in the humidifying chamber 18 is evaporated into a counter-flowing carrier gas 14 (e.g., air) through contact with the heated surfaces of heat-transfer members 16 (e.g., a bank of inter-chamber rods) in a humidifying chamber 18. Secondly, the dehumidification involves liquid condensation from a moist carrier gas 14′ flowing over an opposite end of the heat-transfer members 16 in a dehumidifying chamber 22. Both the humidifying chamber 18 and the dehumidifying chamber 22 are contained within a shared liquid-and-vapor-impermeable housing 17. The opposing ends of each heat-transfer member 16 are involved in the evaporation and condensation processes, respectively, allowing heat 20 to be directly recovered from the latter process to the former. Heat-transfer coefficients representative of those that would be present in air humidification on a heated tube bank and air dehumidification within a cooled tube bank are reported in literature. They are found to be of the order of 200 W/m⁻²K, two orders of magnitude greater than that of certain designs of common heat-transfer wall systems, e.g., as described in the Background section.

The embodiment of the current invention, shown in FIG. 1, includes the following components:
a humidifying chamber 18 into which a carrier gas 14 flows and is heated, and into which a fluid feed 12 is evaporated;
a dehumidifying chamber 22 through which a hot and saturated carrier gas 14′ flows and is cooled, and from which a product fluid 24 is condensed, wherein the carrier gas 14 can circulate between the humidifying and dehumidifying chambers 18 and 22 in a closed loop via connecting conduits;
a mist eliminator 26 (e.g., in the form of a fine mesh, vane or fiber bed having a large surface area in a small volume to collect liquid without substantially impeding gas flow) mounted in an orifice between the humidifying and dehumidifying chambers 18 and 22 preventing the flow of liquid droplets between the chambers 18 and 22;
inter-chamber rods (serving as heat-transfer members 16) penetrating the dividing wall 28 between the humidifying and dehumidifying chambers 18 and 22 and extending across a majority of the horizontal cross-section of each chamber 18/22; evaporation occurs on the surfaces of the rods 16 in the humidifying chamber 18, and condensation occurs on the surfaces of the rods 16 in the dehumidifying chamber 22;
one or more spray nozzles 30 within the humidifying chamber 18, allowing a mist to be generated for the purpose of carrier-gas humidification;
surplus rows 15 of rods 16′ positioned only at the top of the humidification chamber 18 (between the spray nozzle 30 and the inter-chamber heat-transfer rods 16); the surplus rods 16′ absorb heat from the sprayed liquid feed 12; and the carrier gas 14 is heated to a higher temperature and humidified at the surface of the surplus rods 16′, thus providing a driving temperature difference across the inter-chamber rods 16 to allow heat transfer 20 from the dehumidifying chamber 22 to the humidifying chamber 18;
conduits 32 through which liquid feed flows and is heated, positioned in place of certain rods 16 in the inter-chamber rod bundles 36 in such a manner such as to allow the product liquid 24 (purified water) in the dehumidifying chamber 22 and the non-evaporated liquid 34 (i.e., the concentrated brine) in the humidifying chamber 18 to be cooled, and configured to produce a temperature profile wherein the outlet temperature of the product liquid 24 and of the rejected carrier gas 14″ is as close as possible to the temperature of the inlet carrier gas 14;
a heater 40 configured to further heat the liquid feed 12 before it is sprayed into the humidifying chamber 18; and
respective collection receptacles 42 and 44 for capturing the non-evaporated liquid 34 from (at or flowing out of) a bottom position of the humidifying chamber 18 and for the product liquid from (at or flowing out of) a bottom position of the dehumidifying chamber 22.

The inter-chamber rods 16 can be formed of a thermally conductive material or can be in the form of devices, such as heat pipes, that allow heat transfer 20 to occur from the dehumidifier 22 to the humidifier 18. In particular embodiments, the inter-chamber rods 16 (e.g., at least 100 rods) are substantially cylindrical in shape with a diameter, Dᵣ, of 1 mm to 20 mm, a total length of 100 mm to 1 meter, vertical rod spacing of one to five times Dᵣ (e.g., 2×Dᵣ), and horizontal rod spacing of one-half to 5 times Dᵣ (e.g., equal to Dᵣ. The inter-chamber rods 16 can be slotted through the separating wall 28 such that an equal length of each rod 16 is in the humidifying chamber 18 and in the dehumidifying chamber 22; and the rods 16 can fill between 5% and 30% of the shared separating wall 28. For production of 1 m³/day of purified water, around 1,000 inter-chamber rods 16 can be used in the apparatus, though that number can be inversely increased or decreased, depending on the length of the rods.

In embodiments where heat pipes (rather than solid rods) are used as the heat-transfer members 16, the exterior surface of the heat pipes can be formed of a copper-nickel alloy to resist salt corrosion and heat transfer can occur across the pipes via, e.g., evaporation, vapor transfer, and condensation at opposite ends inside the pipes.

The embodiment of FIG. 2 is similar to the embodiment of FIG. 1, except that a packing material 38 with continuous pore structures through which the carrier gas 14 can flow is provided as a pre-humidifier, where the carrier gas 14 is further heated and humidified to enable condensation to occur at a higher temperature on the top rod 16 within the dehumidifier and to enable heat transfer 20 from the dehumidifier 22 to the humidifier 18. The packing material 38 replaces the surplus rods 16′ of FIG. 2, which serve a similar purpose; the packing material 38 can offer greater cost effectiveness and can also offer a higher heat transfer area per unit volume.

The driving temperature difference provided by the surplus rods 16 or packing material 38 can be between 1 and 10 K, wherein that temperature difference is the rise in temperature of the carrier gas 14 as it is humidified amongst the surplus rods 16 or packing material 38. For example, in one embodiment, the liquid feed composition 12 is heated to 65° C. before it is injected into the humidifying chamber 18 at that temperature. The top-most surplus rods 16′ or portion of the packing material 38 are/is promptly heated to a temperature of 64° C. (while lower regions of the surplus rods 16′ or packing material 38 will drift down in temperature by as much as about 3° C.). Meanwhile, the top-most inter-chamber rods 16 can have a temperature of 60° C. in the humidifying chamber 18 and a temperature of 63° C. in the dehumidifying chamber 22 (i.e., a 3° C. temperature difference across each rod 16), thereby driving heat flow 20 from the half of each rod 16 in the dehumidifying chamber 22 to the opposite half of each rod 16 in the humidifying chamber 18.

In one example of the method of operation, the liquid feed composition 12 can be sprayed substantially uniformly into the top of the humidification chamber 18 across a plane orthogonal to the flow of carrier gas 14 at 65° C. (after passing through the humidifying and dehumidifying chambers 18 and 22 and through the heater 40) and at a flow rate of 2-4 kg per minute (for a system producing 1 m³ of purified water per day, operating 24 hours per day). Meanwhile, the carrier gas 14 (e.g., air initially at about 25° C.) can be fed by a blower through the system in counter-flow to the flow of liquid feed composition 12 (i.e., from the bottom to the top of the humidifying chamber 18, from the top of the humidifying chamber 18 to the top of the dehumidifying chamber 22, and from the top to the bottom of the dehumidifying chamber 22) at a flow rate of 20-40 kg per minute for a 1-m³-per-day system.

The concentrated remainder 34 of the liquid feed composition 12 can be collected in a concentrated-remainder collection receptacle 42 at the bottom of or beneath the humidifying chamber 18. Meanwhile, the condensed (purified) water 24 can be collected in the receptacle 44 at the bottom of or beneath the dehumidifying chamber 22.

In particular embodiments, the liquid feed is sprayed into the humidifying chamber with such a concentration of solutes that the liquid feed becomes super-saturated in the humidifier, at the outlet or both, but not sufficiently super-saturated for precipitation to occur within the humidifying chamber. In other embodiments, the liquid feed is sprayed into the humidifying chamber with such a concentration of solutes that the liquid feed reaches a level of super-saturation within the humidifying chamber sufficient for precipitation of the solutes upon wetted surfaces of a plurality of heat-transfer members.

Overall heat-transfer coefficients from the carrier gas in the dehumidifier to the humidifier can be about 200 W/m⁻²K or two orders of magnitude greater than other systems with direct heat recovery. Consequently, the heat-transfer area required per unit of product liquid produced can be drastically reduced with these apparatus and methods. The replacement of rods 16 in an appropriate manner with conduits 31 (pipes) for preheating the feed liquid 12 can allow the product liquid 24 and rejected liquid streams 34 to be cooled in a much more ideal manner than is possible with current systems, resulting in a system with significantly lower thermal-energy requirements.

In particular embodiments, the only active heating via an external heat/energy source is the heating of the feed liquid 12 by a heater 40 (e.g., a solar water heater with arrays of tubes directly heated by sunlight, a natural-gas-burning heater, or a heat exchanger in which a stream of waste heat is used to heat the water) before spraying the feed liquid 12 into the humidification chamber 18, with no need for the injection of vapor or for the heating of the carrier gas 14 at any point in the system in contrast with current carrier-gas systems that may require steam injection or carrier-gas heating in addition to heating the feed. The simple heating system described herein can greatly simplify overall system design, operation and maintenance. Liquid heating is advantageous as it is the least costly of air, liquid and steam heating, especially for seawater.

Water can be desalinated with these apparatus with low heat consumption per water produced, as the apparatus efficiently recover heat during the desalination process. The gained output ratio (GOR, which is the ratio of product water/heat input) in these methods can be about 5 or even 10, which is much higher than many previous systems, such as those that use separate humidification and dehumidification apparatus, where GOR may be less than 2.5. The gained output ratio can be calculated as follows:

$$GOR = \frac{{\dot{m}}_{pw} {h}_{fg}}{\dot{Q}} ,$$

where \dot{m}_{pw} is the mass flow of product water, h_{fg} is the latent heat of evaporation, and \dot{Q} is the heat input.

Moreover, the single-pass recovery ratio (RR, which is the ratio of water produced/feed water) for these apparatus and methods can be 80% (e.g., 80 kg of product purified water and 20 kg of remaining brine per 100 kg of feed seawater), which is also significantly higher than the single-pass recovery ratio in many previous approaches that employed separate humidification and dehumidification apparatus or a common wall for humidification.

Exemplary applications for these methods and apparatus include the following: (a) seawater or brackish water desalination using a low-temperature heat source, such as solar radiation or biofuels, and (b) dehydration (concentration) of municipal and industrial wastewater streams, including frac'ing waters (where a higher recovery ratio leads to a lower volume of remaining concentrate and lower consequent trucking costs for removal), using traditional fuels, solar radiation, geothermal heat sources or waste-heat sources from industrial processes.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{rd}½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A humidification-dehumidification apparatus, comprising:
a housing including a shared interior wall extending along a vertical axis and defining a humidifying chamber and a dehumidifying chamber adjacent to the humidifying chamber, wherein the humidifying chamber and the dehumidifying chamber are separated by the shared interior wall, wherein the shared interior wall defines an orifice through which a carrier gas can pass from the humidifying chamber into the dehumidifying chamber;
a plurality of heat-transfer members extending through the shared interior wall and across a majority of each chamber along a horizontal axis;
a spray device configured to direct a spray of liquid feed composition onto the heat-transfer members inside the humidifying chamber; and
a conduit for feeding a liquid feed through the spray device.

2. The humidification-dehumidification apparatus of claim 1, further comprising:
a concentrated-remainder collection receptacle configured to collect a liquid remainder from the humidifying chamber; and
a product-liquid collection receptacle configured to collect condensed liquid from the dehumidifying chamber.

3. The humidification-dehumidification apparatus of claim 2, wherein the concentrated-remainder collection receptacle is configured to collect the liquid remainder from a bottom position in the humidifying chamber, wherein the product-liquid collection receptacle is configured to collect the condensed liquid from a bottom position in the dehumidifying chamber, and wherein the spray device is configured to spray the feed liquid at a top position in the humidifying chamber.

4. The humidification-dehumidification apparatus of claim 1, wherein the heat-transfer members are in the form of elongate rods.

5. The humidification-dehumidification apparatus of claim 4, wherein the elongate rods have a diameter in a range from 1 mm to 20 mm and a length from 100 mm to 1 meter.

6. The humidification-dehumidification apparatus of claim 4, wherein the rods have a spacing along the vertical axis of about two times the rod diameter and spacing along the horizontal axis that is about equal to the rod diameter.

7. The humidification-dehumidification apparatus of claim 4, wherein the rods fill between 5% and 30% of the shared interior wall.

8. The humidification-dehumidification apparatus of claim 4, wherein the rods have a surface that comprises a copper-nickel alloy.

9. The humidification-dehumidification apparatus of claim 8, wherein the rods are heat pipes.

10. The humidification-dehumidification apparatus of claim 4, wherein at least 100 rods are included in the apparatus.

11. The humidification-dehumidification apparatus of claim 1, further comprising a heater configured to heat the liquid within the conduit for feeding liquid feed composition through the spray device.

12. The humidification-dehumidification apparatus of claim 11, wherein the conduit for feeding liquid feed composition through the spray device passes back-and-forth through the humidifying chamber and through the dehumidifying chamber.

13. The humidification-dehumidification apparatus of claim 1, further comprising a source of liquid feed composition in fluid communication with the conduit.

14. The humidification-dehumidification apparatus of claim 1, further comprising a blower configured to direct gas (a) from a bottom position in the humidifying chamber to a top position in the humidifying chamber, (b) from the top position in the humidifying chamber through the orifice in the shared interior wall to a top position in the dehumidifying chamber, and (c) from the top position in the dehumidifying chamber to a bottom position in the dehumidifying chamber.

15. The humidification-dehumidification apparatus of claim 1, further comprising a mist eliminator positioned in the orifice defined by the shared wall to restrict liquid from passing from the humidifying chamber into the dehumidifying chamber with the carrier gas.

16. The humidification-dehumidification apparatus of claim 1, further comprising a pre-humidifier including a heat-transfer surface between the spray device and the heat-transfer members in the humidifying chamber but not in the dehumidifying chamber.

17. A method for purifying water or for concentrating solute, comprising:
spraying a liquid feed into a humidifying chamber of a humidification-dehumidification apparatus, wherein the humidification-dehumidification apparatus includes (a) the humidifying chamber and (b) a dehumidifying chamber, wherein a shared wall separates the humidifying chamber from the dehumidifying chamber, and (c) a bank of heat-transfer members that extend on opposite sides of the shared wall into the humidifying chamber and into the dehumidifying chamber, and wherein the liquid feed includes water and at least one other composition dissolved in the water;
collecting the liquid feed on the heat-transfer members in the humidifying chamber as the liquid feed passes through the humidifying chamber;
evaporating water from the liquid feed that was collected on the heat-transfer members, leaving a concentrated remainder of the liquid feed in liquid form;
draining the concentrated remainder of the liquid feed from the humidifying chamber;
passing a flow of carrier gas through the humidifying chamber in counter-flow to the spray of liquid feed;
entraining the evaporated water in the flow of carrier gas to form a moist carrier gas;
passing the flow of the moist carrier gas from the humidifying chamber to the dehumidifying chamber;
condensing the water vapor from the moist carrier gas on the bank of heat-transfer members in the dehumidifying chamber;
transferring heat of condensation and sensible heat from cooling the moist carrier gas and the condensed water across the heat-transfer members from the dehumidifying chamber to the humidifying chamber; and
draining the condensed water from the dehumidifying chamber to a collection receptacle.

18. The method of claim 17, further comprising passing the liquid feed through a conduit passing through the humidifying chamber and through the dehumidifying chamber, wherein the liquid feed is pre-heated within the humidifying and dehumidifying chambers, and wherein heat is transferred from the dehumidifying chamber to the humidifying chamber, before spraying the liquid feed into the humidifying chamber.

19. The method of claim 17, further comprising heating the liquid feed by supplying external heat before spraying the liquid feed into the humidifying chamber.

20. The method of claim 19, wherein substantially all of the external heating provided to the liquid feed and to the carrier gas is via the external heat supplied to the liquid feed before the liquid feed is sprayed into the humidifying chamber.

21. The method of claim 17, wherein the carrier gas and the liquid feed pass through the humidifying chamber along a vertical axis, and wherein the heat-transfer members at a common position along the vertical axis are warmer in the dehumidifying chamber than in the humidifying chamber.

22. The method of claim 21, wherein heat transfer members that are closer to where the liquid feed is sprayed into the humidifying chambers have a higher temperature than heat transfer members that are further from where the liquid feed is sprayed into the humidifying chamber.

23. The method of claim 17, wherein the liquid feed is sprayed substantially uniformly in the humidifying chamber across a plane orthogonal to the flow of carrier gas through the humidifying chamber.

24. The method of claim 17, wherein heat is transferred across the shared wall from the dehumidifying chamber to the humidifying chamber at a rate of at least 20 W/m².

25. The method of claim 17, wherein the condensed water is collected with a recovery ratio of at least 80% from the liquid feed.

26. The method of claim 17, wherein the liquid feed is selected from the following:
sea water or brackish water from which substantially pure water is evaporated, condensed and drained;
a waste stream from a municipal or industrial source, and wherein the concentrated remainder removed from the humidifying chamber includes the waste from the waste stream at a higher concentration than the concentration of the waste in the waste stream when the waste stream is sprayed into the humidifying chamber; and
water from hydraulic-fracturing for gas or oil extraction.

27. The method of claim 17, wherein the carrier gas is circulated through the humidifying chamber and the dehumidifying chamber in a closed loop.

28. The method of claim 17, wherein the liquid feed is sprayed into the humidifying chamber with such a concentration of solutes that the liquid feed becomes super-saturated in the humidifier, at the outlet or both, but not sufficiently super-saturated for precipitation to occur within the humidifying chamber.

29. The method of claim 17, wherein the liquid feed is sprayed into the humidifying chamber with such a concentration of solutes that the liquid feed reaches a level of super-saturation within the humidifying chamber sufficient for precipitation of the solutes upon wetted surfaces of a plurality of heat-transfer members.
